(19) United States
(12) Patent Application Publication
(10) Pub. No.: US 2011/0104497 A1
(43) Pub. Date: May 5, 2011

(54) Reinforced fiber blank and process of manufacturing same

(76) Inventors: Shui Yuan Ma, Taipei (TW); Ling-Ling Cheng, Taipei (TW)

(21) Appl. No.: 12/608,006

(22) Filed: Oct. 29, 2009

(51) Int. Cl. B32B 5/02; B32B 37/06; B32B 38/08; B32B 9/04; B32B 17/04; B32B 27/30; B32B 19/02; B32B 27/32; B32B 27/36; B32B 27/04; B32B 27/06; B32B 27/34; B32B 27/18

(52) U.S. Cl. 428/408; 156/308.2; 156/309.9; 428/411.1; 428/426; 428/443; 428/521; 428/523; 428/522; 428/480; 428/474.4; 428/473.5; 428/412

(57) ABSTRACT

A reinforced fiber blank and process of manufacturing same are provided. The process includes passing a continuous fiber sheet through a bath of thermoplastic resin so that the thermoplastic resin permeates the continuous fiber sheet to form a continuous fiber substrate permeated with the thermoplastic resin; stacking at least one fiber substrate and at least one thermoplastic resin layer to form a stack; and heating and pressing the stack at a temperature between about 60° C. and 150° C. to produce the finished reinforced fiber blank.

### BACKGROUND OF THE INVENTION

1. Field of Invention

The invention relates to fibrous articles and more particularly to a reinforced fiber blank and process of manufacturing same with improved characteristics.

2. Description of Related Art

Plastic products are widely used in our daily life. Moreover, a plastic article having an increased structural strength is always desired. Therefore, techniques of manufacturing such plastic articles have been developed.

Conventional processes of manufacturing a fiber blank suffer from several disadvantages. For example, they are complicated and expensive. Thus, the need for improvement still exists.

### SUMMARY OF THE INVENTION

It is therefore one object of the invention to provide a process of manufacturing a reinforced fiber blank.

It is another object of the invention to provide a reinforced fiber blank.

The above and other objects, features and advantages of the invention will become apparent from the following detailed description taken with the accompanying drawings.

### BRIEF DESCRIPTION OF THE DRAWINGS

FIGS. 1 to 4 are schematic longitudinal sectional views showing first, second, third, and fourth preferred embodiments of stacking fiber substrate(s) and thermoplastic resin layer(s) according to the invention.

### DETAILED DESCRIPTION OF THE INVENTION

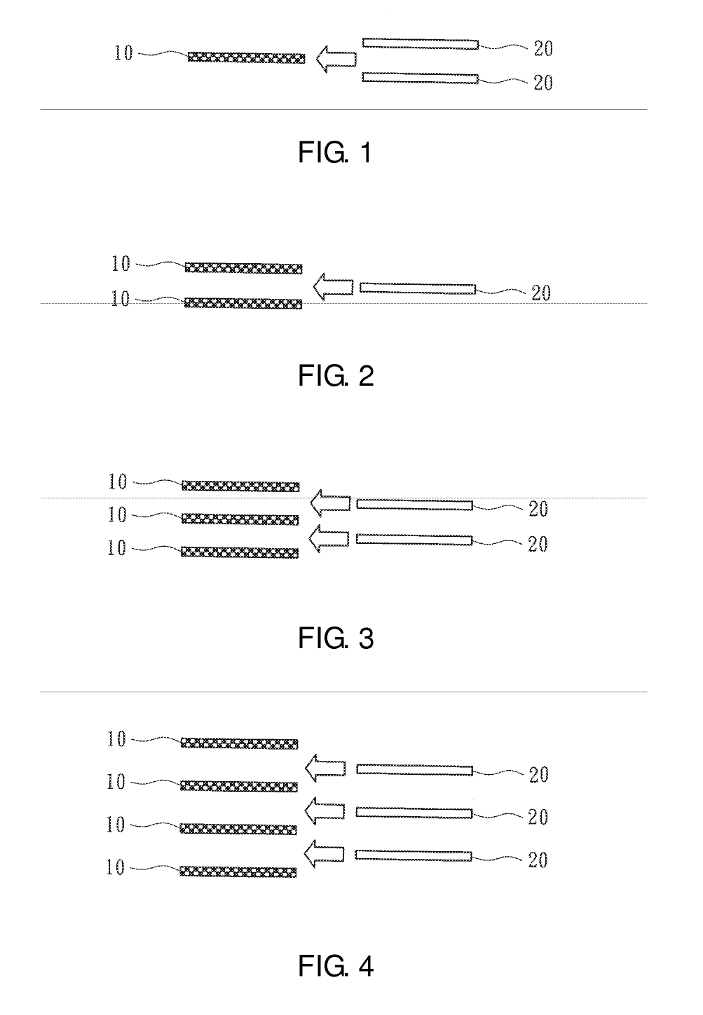

Referring to FIGS. 1 to 4, a reinforced fiber blank according to the invention is shown by illustrating a process of manufacturing same.

In a first step of the process, a continuous fiber sheet is conveyed by rollers to pass through a bath of thermoplastic resin. The thermoplastic resin permeates the continuous fiber sheet and thus a continuous fiber substrate 10 permeated with the thermoplastic resin is formed.

Material of the continuous fiber sheet is selected from the group consisting of carbon fiber, glass fiber, synthetic fiber, natural fiber, and asbestos.

Material of the thermoplastic resin is selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

In a second step of the process, the fiber substrate 10 is baked at a temperature of between about 40° C. and 80° C. until the thermoplastic resin in the fiber substrate 10 becomes gel.

In a third step of the process, the fiber substrate(s) 10 and thermoplastic resin layer(s) 20 are stacked together. Material of the thermoplastic resin in the thermoplastic resin layer 20 is selected from the group consisting of ABS, PS, PC, PE, AS, PMMA, PET, PA, PBT, PEEK, and PEI. Alternatively, the material of the thermoplastic resin in the thermoplastic resin layer 20 is selected from the group consisting of ABS, PS, PC, PE, AS, PMMA, PET, PA, PBT, PEEK, PEI, and an alloy resin formed by adding an additive (e.g., at least one of talc, carbon fiber, and glass fiber) to any of ABS, PS, PC, PE, AS, PMMA, PET, PA, PBT, PEEK, and PEI.

In a first preferred embodiment as shown in FIG. 1, a single fiber substrate 10 is sandwiched between two thermoplastic resin layers 20.

In a second preferred embodiment as shown in FIG. 2, a single thermoplastic resin layer 20 is sandwiched between two fiber substrates 10.

In a third preferred embodiment as shown in FIG. 3, a first thermoplastic resin layer 20 is sandwiched between an upper fiber substrate 10 and an intermediate fiber substrate 10, and a second thermoplastic resin layer 20 is sandwiched between the intermediate fiber substrate 10 and a lower fiber substrate 10.

In a fourth preferred embodiment as shown in FIG. 4, a first thermoplastic resin layer 20 is sandwiched between an upper fiber substrate 10 and an upper intermediate fiber substrate 10, a second thermoplastic resin layer 20 is sandwiched between the upper intermediate fiber substrate 10 and a lower intermediate fiber substrate 10, and a third thermoplastic resin layer 20 is sandwiched between the lower intermediate fiber substrate 10 and a lower fiber substrate 10.

In a fourth step of the process, a hydraulic press machine (not shown) is employed to press any of the stacks at a high temperature of between about 60° C. and 150° C. until a reinforced fiber blank is produced.

Preferably, the thermoplastic resin layer 20 is black in order to increase shading capability of the product.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing a reinforced fiber blank comprising the steps of:
(a) passing a continuous fiber sheet through a bath of thermoplastic resin so that the thermoplastic resin permeates the continuous fiber sheet to form a continuous fiber substrate permeated with the thermoplastic resin;
(b) stacking at least one fiber substrate and at least one thermoplastic resin layer to form a stack; and
(c) heating and pressing the stack at a first temperature to produce the finished reinforced fiber blank.

2. The process of claim 1, wherein the continuous fiber sheet is formed of a material selected from the group consisting of carbon fiber, glass fiber, synthetic fiber, natural fiber, and asbestos.

3. The process of claim 1, wherein the thermoplastic resin is selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

4. The process of claim 1, further comprising the sub-step of heating the fiber substrate at a second temperature until the thermoplastic resin in the fiber substrate becomes gel after step (a).

5. The process of claim 4, wherein the second temperature is in a range of 40° C. to 80° C.

6. The process of claim 1, wherein the first temperature is in a range of 60° C. to 150° C.

7. The process of claim 1, wherein the thermoplastic resin layer is formed of a material selected from the group consisting of ABS, PS, PC, PE, AS, PMMA, PET, PA, PBT, PEEK, and PEI.

8. The process of claim 1, wherein the thermoplastic resin layer is formed of a material selected from the group consisting of ABS, PS, PC, PE, AS, PMMA, PET, PA, PBT, PEEK, PEI, and an alloy resin formed by adding an additive to any of ABS, PS, PC, PE, AS, PMMA, PET, PA, PBT, PEEK, and PEI.

9. The process of claim 8, wherein the additive is selected from the group consisting of talc, carbon fiber, and glass fiber.

10. A reinforced fiber blank comprising:
at least one fiber substrate permeated with thermoplastic resin; and
at least one thermoplastic resin layer.

11. The reinforced fiber blank of claim 10, wherein fiber in the fiber substrate is formed of a material selected from the group consisting of carbon fiber, glass fiber, synthetic fiber, natural fiber, and asbestos.

12. The reinforced fiber blank of claim 10, wherein the thermoplastic resin is selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

13. The reinforced fiber blank of claim 10, wherein the thermoplastic resin layer is formed of a material selected from the group consisting of ABS, PS, PC, PE, AS, PMMA, PET, PA, PBT, PEEK, and PEI.

14. The reinforced fiber blank of claim 10, wherein the thermoplastic resin layer is formed of a material selected from the group consisting of ABS, PS, PC, PE, AS, PMMA, PET, PA, PBT, PEEK, PEI, and an alloy resin formed by adding an additive to any of ABS, PS, PC, PE, AS, PMMA, PET, PA, PBT, PEEK, and PEI.

15. The reinforced fiber blank of claim 14, wherein the additive is selected from the group consisting of talc, carbon fiber, and glass fiber.
